(19) United States
(12) Patent Application Publication
(10) Pub. No.: US 2013/0072069 A1
(43) Pub. Date: Mar. 21, 2013

(54) CHARGER

(71) Applicants: LEI GAO, Dong-Guan (CN); Yin-Lung Wu, New Taipei City (CN); Bing-Tao Yang, Dong-Guan (CN); Ming-Chiang Chen, New Taipei City (TW)

(72) Inventors: LEI GAO, Dong-Guan (CN); Yin-Lung Wu, New Taipei City (CN); Bing-Tao Yang, Dong-Guan (CN); Ming-Chiang Chen, New Taipei City (TW)

(73) Assignee: Cheng Uei Precision Industry Co., LTD., New Taipei City (TW)

(21) Appl. No.: 13/233,033

(22) Filed: Sep. 15, 2011

(51) Int. Cl. H01R 24/00

(52) U.S. Cl. 439/660

(57) ABSTRACT

A charger includes a female connector disposed in a mobile phone, and a male connector mated with the female connector and adapter for electrically connecting with an external power supply. The female connector includes an insulating housing defining a receiving chamber, first electrical terminals each having one end thereof embedded in the insulating housing and the other end thereof exposed in the receiving chamber, and second electrical terminals of which each has one end embedded in the insulating housing and further electrically connected with the one end of the corresponding first electrical terminal, and the other end projected out of the insulating housing to be connected with a mobile phone PCB. The male connector has electrical contacts exposed outward, and can be removably inserted in the receiving chamber of the female connector to realize an electrical connection between the electrical contacts and the corresponding first electrical terminals.

### BACKGROUND OF THE INVENTION

1. Field of the Invention

The present invention relates to a charger, and more particularly to a charger for a mobile phone, which is easy to carry for the convenience of charging the mobile phone.

2. The Related Art

At present, with the development of the telecommunications industry, mobile phones have brought great convenience for people's life and work. However, after using the mobile phones for a period of time, they need charging. Generally, there are two manners for charging the mobile phones. The first charging manner for the mobile phone is realized by a data cable connecting the mobile phone and a charger plug capable of connecting with a power supply. However, it results in an inconvenient trip on account of needing to simultaneously take the data cable and the charger plug during the trip of a user. The second charging manner for the mobile phone is realized by dismounting a battery from the mobile phone and then utilizing a charger to charge the battery, so that results in a complicated charging operation and an unavailability of the mobile phone during charging the battery. So, a charger capable of overcoming the above-mentioned problems is demanded.

### SUMMARY OF THE INVENTION

An object of the present invention is to provide a charger for a mobile phone. The charger includes a female connector disposed in the mobile phone, and a male connector mated with the female connector and adapter for electrically connecting with an external power supply. The female connector includes an insulating housing defining a receiving chamber, first electrical terminals each having one end thereof embedded in the insulating housing and the other end thereof exposed in the receiving chamber, and second electrical terminals of which each has one end embedded in the insulating housing and further electrically connected with the one end of the corresponding first electrical terminal, and the other end projected out of the insulating housing to be electrically connected with a mobile phone PCB. The male connector has electrical contacts exposed outward. The male connector can be removably inserted in the receiving chamber of the female connector to realize an electrical connection between the electrical contacts and the corresponding first electrical terminals.

As described above, the charger of the present invention includes the female connector disposed in the mobile phone and the male connector adapter to be connected with the power supply. When the mobile phone needs to be charged, directly place the mobile phone onto the male connector to realize the electrical connection between the female connector and the male connector. So, the charge for the mobile phone can be directly achieved without the data cable and the process of dismounting a battery from the mobile phone in the prior art, so that realizes the convenience of taking the mobile phone and charging the mobile phone during the trip.

### BRIEF DESCRIPTION OF THE DRAWINGS

The present invention will be apparent to those skilled in the art by reading the following description, with reference to the attached drawings, in which:

FIG. 1 is a perspective view showing that a charger in accordance with an embodiment of the present invention is connected with a mobile phone PCB and a power supply PCB;

FIG. 2 is a perspective view of the charger of FIG. 1, wherein a female connector and a male connector of the charger are engaged with each other;

FIG. 3 is a perspective view of the charger of FIG. 2, wherein the female connector is disengaged from the male connector;

FIG. 4 is another angle of perspective view of the charger of FIG. 3;

FIG. 5 is an exposed view of the female connector of the charger of FIG. 2;

FIG. 6 is another angle of exposed view of the female connector of FIG. 5;

FIG. 7 is a lateral view of the charger of FIG. 2; and

FIG. 8 is a cross-sectional view of the charger of FIG. 7 along the line A-A.

### DETAILED DESCRIPTION OF THE PREFERRED EMBODIMENT

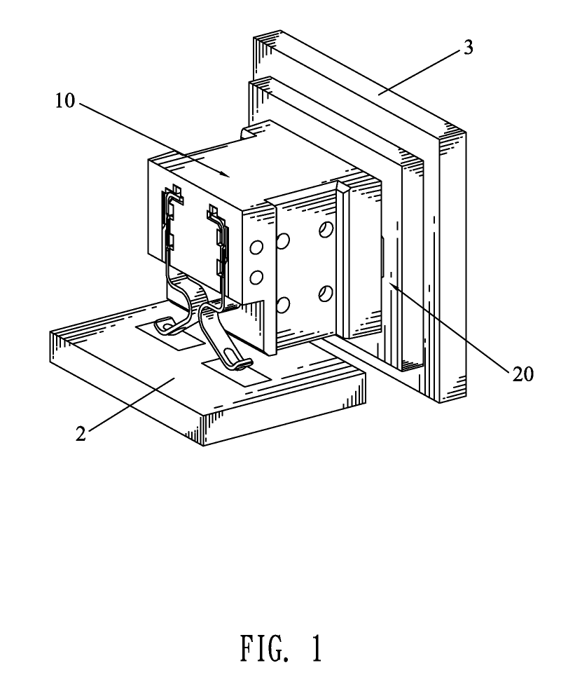

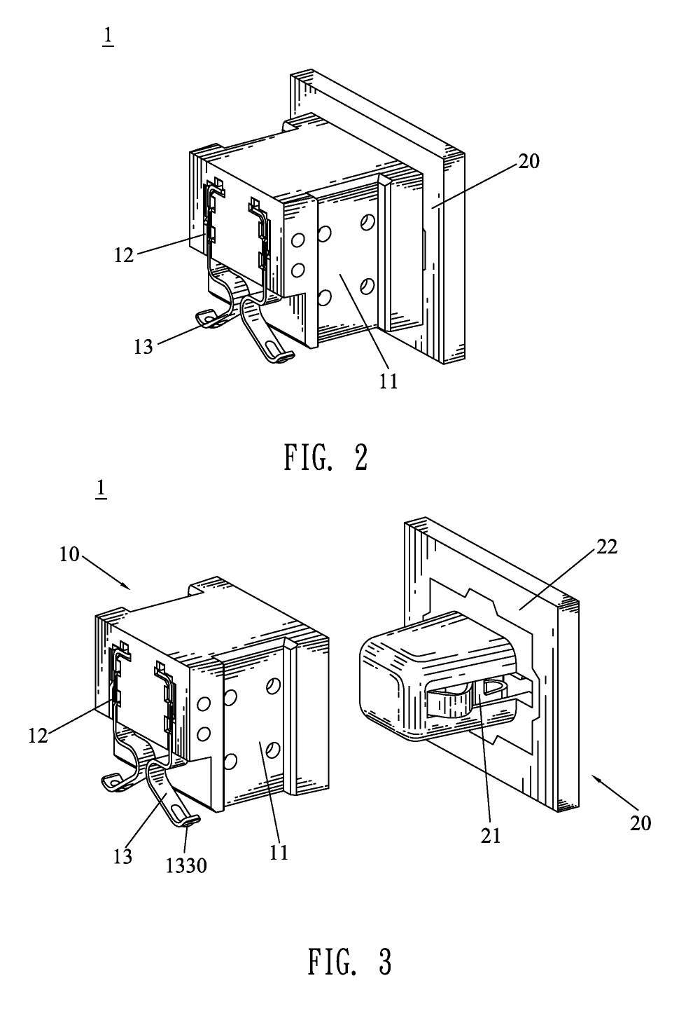

Referring to FIGS. 1-4, a charger 1 for a mobile phone (not shown) in accordance with an embodiment of the present invention includes a female connector 10 and a male connector 20 mated with the female connector 10. The female connector 10 is disposed in the mobile phone, and includes an insulating housing 11, first electrical terminals 12 and second electrical terminals 13. The insulating housing 11 defines a receiving chamber 110 for the insertion of the male connector 20 therein. The first electrical terminal 12 has one end thereof embedded in the insulating housing 11 and the other end thereof exposed in the receiving chamber 110. The second electrical terminals 13 each has one end thereof embedded in the insulating housing 11 and further electrically connected with the one end of the corresponding first electrical terminal 12, and the other end thereof projected out of the insulating housing 11 to be electrically connected with a mobile phone PCB 2. The male connector 20 is adapted for electrically connecting with an external power supply (not shown) and has electrical contacts 21 exposed outward. The male connector 20 is removably inserted in the receiving chamber 110 of the female connector 10 to realize an electrical connection between the electrical contacts 21 and the corresponding first electrical terminals 12.

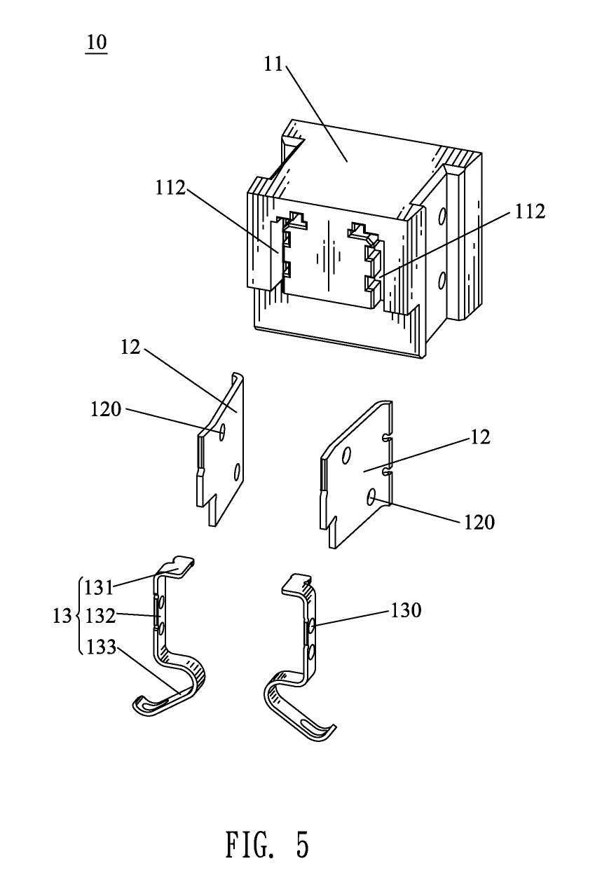

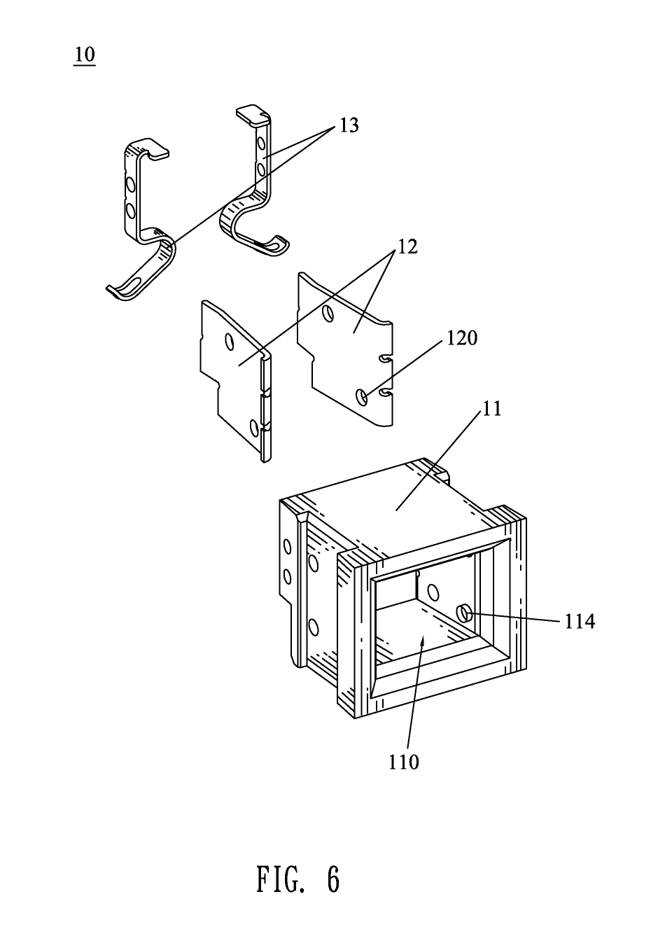

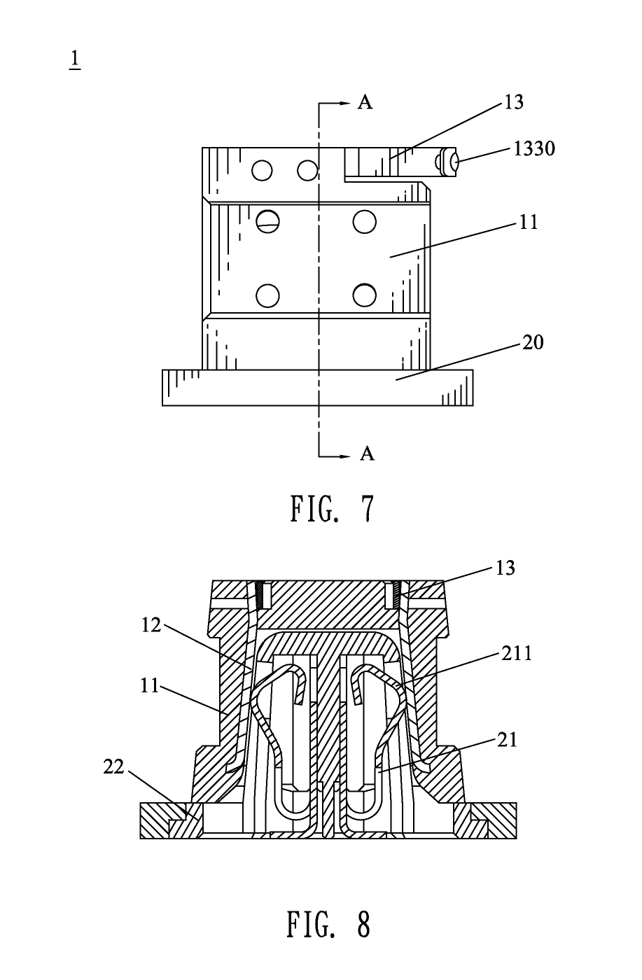

Referring to FIG. 1 and FIGS. 3-7, one end face of the insulating housing 11 is concaved inward to form the receiving chamber 110, and the other opposite end face of the insulating housing 11 defines two receiving cavities 112 communicated with the receiving chamber 110 and spaced from each other to be adjacent to two opposite insides of the receiving chamber 110. The two opposite insides of the receiving chamber 110 respectively define a plurality of fastening pillars 114. A part of each first electrical terminal 12 exposed in the receiving chamber 110 defines a plurality of fastening holes 120 securing the respective fastening pillars 114 therein so as to make the other end of the first electrical terminal 12 firmly against the corresponding inside of the receiving chamber 110 and exposed in the receiving chamber 110. The second electrical terminal 13 has a connecting arm 132, a fastening tail 131 perpendicularly bent sideward from a top edge of the connecting arm 132, and a substantially V-shaped elastic arm 133 connected with a bottom edge of the connecting arm 132. The connecting arm 132 of the second electrical terminal 13 and the one end of the first electrical terminal 12 are received in the corresponding receiving cavity 112 of the insulating housing 11 and electrically connect with each other. One side of the connecting arm 132 against the one end of the first electrical terminal 12 protrudes sideward to form a plurality of lumps 130 resisting against the one end of the first electrical terminal 12. The fastening tail 131 is also embedded in the receiving cavity 112 to secure the second electrical terminal 13 in the insulating housing 11. A distal end of the elastic arm 133 is designed with a contact projection 1330 thereon, and the elastic arms 133 stretches out of the insulating housing 11 to make the contact projection 1330 electrically contact with the mobile phone PCB 2.

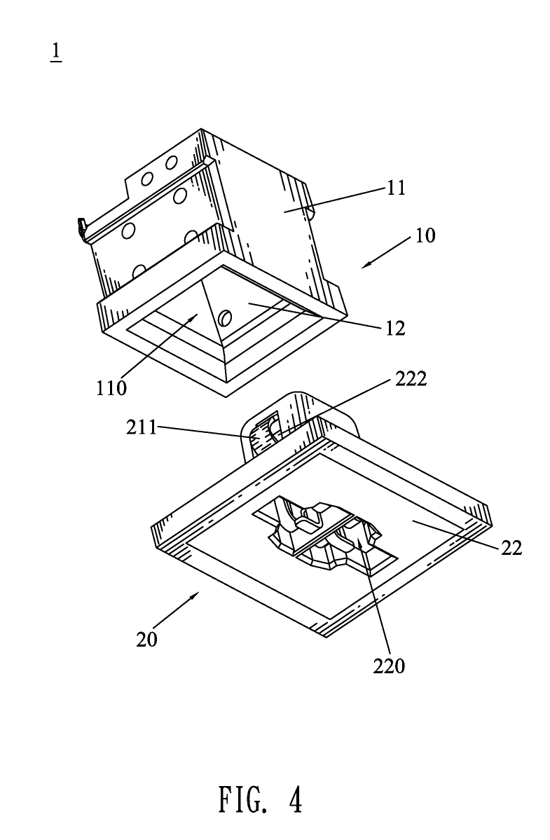

Referring to FIG. 1, FIG. 3, FIG. 4 and FIG. 8, the male connector 20 includes a base body 22 defining two inserting cavities 220 therein. Two opposite outsides of the base body 22 define two openings 222 respectively communicated with the inserting cavities 220. The electrical contacts 21 are assembled in the inserting cavities 220 respectively and each has one end thereof connected with a power supply PCB 3. The other end of each electrical contact 21 is arched outward to form a contact portion 211 elastically projecting outward out of the corresponding opening 222. When the mobile phone needs to be charged, the male connector 20 is inserted into the receiving chamber 110 of the female connector 10 to make the contact portions 211 of the electrical contacts 21 electrically connect with the first electrical terminals 12, respectively.

As described above, the charger 1 of the present invention includes the female connector 10 disposed in the mobile phone and the male connector 20 adapter to be connected with the power supply. When the mobile phone needs to be charged, directly place the mobile phone onto the male connector 20 to realize the electrical connection between the female connector 10 and the male connector 20. So, the charge for the mobile phone can be directly achieved without the data cable and the process of dismounting a battery from the mobile phone in the prior art, so that realizes the convenience of taking the mobile phone and charging the mobile phone during the trip.

What is claimed is:

1. A charger for a mobile phone, comprising:
a female connector disposed in the mobile phone, the female connector including an insulating housing defining a receiving chamber, first electrical terminals each having one end thereof embedded in the insulating housing and the other end thereof exposed in the receiving chamber, and second electrical terminals of which each has one end embedded in the insulating housing and further electrically connected with the one end of the corresponding first electrical terminal, and the other end projected out of the insulating housing to be electrically connected with a mobile phone PCB; and
a male connector mated with the female connector and adapter for electrically connecting with an external power supply, the male connector having electrical contacts exposed outward, wherein the male connector can be removably inserted in the receiving chamber of the female connector to realize an electrical connection between the electrical contacts and the corresponding first electrical terminals.

2. The charger as claimed in claim 1, wherein one end face of the insulating housing is concaved inward to form the receiving chamber, the other opposite end face of the insulating housing defines two receiving cavities communicated with the receiving chamber and spaced from each other, the second electrical terminal has a connecting arm, a fastening tail bent sideward from one end edge of the connecting arm, and a substantially V-shaped elastic arm connected with the other end edge of the connecting arm, the connecting arm of the second electrical terminal and the one end of the first electrical terminal are embedded in the corresponding receiving cavity and electrically connect with each other, the fastening tail is also embedded in the receiving cavity to secure the second electrical terminal in the insulating housing.

3. The charger as claimed in claim 2, wherein one side of the connecting arm of the second electrical terminal against the one end of the first electrical terminal protrudes sideward to form a plurality of lumps resisting against the one end of the first electrical terminal.

4. The charger as claimed in claim 1, wherein two opposite insides of the receiving chamber of the insulating housing respectively define a plurality of fastening pillars, a part of each first electrical terminal exposed in the receiving chamber defines a plurality of fastening holes securing the respective fastening pillars therein to make the other end of the first electrical terminal firmly against the corresponding inside of the receiving chamber and exposed in the receiving chamber.

5. The charger as claimed in claim 1, wherein the male connector includes a base body defining two inserting cavities therein, two opposite outsides of the base body define two openings respectively communicated with the inserting cavities, the electrical contacts are assembled in the inserting cavities respectively and each has one end thereof connected with the power supply and the other end thereof elastically projecting outward out of the corresponding opening to electrically connect with the corresponding first electrical terminal.
